(19) United States
(12) Patent Application Publication
(10) Pub. No.: US 2008/0288232 A1
(43) Pub. Date: Nov. 20, 2008

(54) BRIDGE PROGRAM, BRIDGE METHOD, AND SIMULATOR

(75) Inventors: Shogo Ishii, Tokyo (JP); Toshiyuki Ohno, Tokyo (JP); Akira Ishitsuka, Tokyo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA SOLUTIONS CORPORATION, Tokyo (JP)

(21) Appl. No.: 12/111,607

(22) Filed: Apr. 29, 2008

(30) Foreign Application Priority Data
May 15, 2007 (JP) 2007-128771

(51) Int. Cl. G06G 7/62

(52) U.S. Cl. 703/20

(57) ABSTRACT

An object of the present invention is to provide a bridge program capable of achieving common use of the interface between a plurality of modules having different configurations and a hardware model obtained by modeling hardware with software.

A bridge program allows a computer to execute: an acquisition step that acquires an operation instruction issued from the module to hardware model; a conversion step that converts the interface of the module into a common interface corresponding to the hardware model; and a discrimination step that acquires the operation instruction acquired by the acquisition step via the common interface into which the interface of the module is converted by the conversion step, discriminates to which hardware model the operation instruction is issued, and outputs the operation instruction to the discriminated hardware model.

### BACKGROUND OF THE INVENTION

1. Field of the Invention

The present invention relates to a bridge program and a bridge method that convert a specific interface for a plurality of modules having different configurations into a common interface to enable connection between the modules and a hardware model, and a simulator executing the bridge program.

2. Description of the Related Art

In a development process of a product constituted by a CPU and peripheral hardware, a simulator is used to verify the operation of a part or the entire part of components included in the product.

In most cases, configurations differ between simulators depending on a target product to be verified. In one simulator, a CPU model for simulating a CPU function is implemented by hardware and a hardware model for simulating the function of peripheral hardware other than hardware modeled by the CPU model is implemented by software on a computer. In another simulator, both the CPU model and hardware model are implemented by software on a computer.

Even when configurations differ between simulators as described above, there is often a case where the same function is implemented on the hardware model although the configurations of the CPU models are different from each other. In such a case, in order to reduce development cost and time of the product and in terms of software quality maintenance and effective use of resources, it is desirable to reuse the existing hardware model as much as possible.

As a prior art relating to the present invention, there is known a system simulator that verifies in an integrated manner a program and hardware of an electronic apparatus using a microcomputer (e.g., Patent Document 1: Jpn. Pat. Appln. Laid-Open Publication No. 2000-35898). This system simulator includes: a hardware simulator that uses software to verify the hardware based on the program; a virtual model simulator that uses software to process, in an equivalent manner to the hardware, a command issued from the program with respect to the hardware; and a CPU model simulator that uses software to verify the program while appropriately utilizing the output of the hardware simulator or virtual model simulator.

However, when configurations of the CPU models are different between, e.g., two simulators, the interface of the existing hardware model that agrees with the interface of one CPU model does not agree with that of another CPU model, so that it is necessary to design a new hardware model so as to make the interface of the hardware model agree with the interface of the CPU model. As a result, reduction of product development cost and development time, quality maintenance of the hardware model, and effective use of resources cannot be achieved.

Patent Document 1 does not disclose or suggest a mechanism for eliminating the disagreement between the interfaces caused when configurations differ between simulators as described above.

### SUMMARY OF THE INVENTION

The present invention has been made to solve the above problem, and an object thereof is to provide a bridge program and a bridge method capable of achieving common use of the interface between a plurality of CPU models having different configurations and a hardware model, and a simulator executing the bridge program.

To solve the above problem, according to a first aspect of the present invention, there is provided a bridge program allowing a computer to connect a plurality of modules having different configurations from each other which are implemented by software or hardware and at least one hardware model obtained by modeling hardware with software, the program allowing the computer to execute: an acquisition step that acquires an operation instruction issued from the module to hardware model; a conversion step that converts the interface of the module into a first interface corresponding to the hardware model; a discrimination step that acquires the operation instruction acquired by the acquisition step via the first interface into which the interface of the module is converted by the conversion step, discriminates to which hardware model the operation instruction is issued, and outputs the operation instruction to the discriminated hardware model.

The bridge program further allows the computer to execute: a first output step that acquires an operation status of the hardware model output in response to the operation instruction from the hardware model and outputs the operation status via the first interface into which the interface of the module is converted by the conversion step; and a second output step that converts the first interface into the interface of the module and outputs the operation status output by the first output step to the module via the interface of the module into which the first interface is converted.

In the bridge program according to the present invention, the conversion step performs the conversion into the first interface based on information concerning the module.

In the bridge program according to the present invention, the discrimination step discriminates to which hardware model the operation instruction is issued based on information concerning the hardware model.

Further, to solve the above problem, according to a second aspect of the present invention, there is provided a bridge method that connects a plurality of modules having different configurations from each other which are implemented by software or hardware and at least one hardware model obtained by modeling hardware with software, comprising: an acquisition step that acquires an operation instruction issued from the module to hardware model; a conversion step that converts the interface of the module into a first interface corresponding to the hardware model; a discrimination step that acquires the operation instruction acquired by the acquisition step via the first interface into which the interface of the module is converted by the conversion step, discriminates to which hardware model the operation instruction is issued, and outputs the operation instruction to the discriminated hardware model.

The bridge method according the present invention further comprises: a first output step that acquires an operation status of the hardware model output in response to the operation instruction from the hardware model and outputs the operation status via the first interface into which the interface of the module is converted by the conversion step; and a second output step that converts the first interface into the interface of the module and outputs the operation status output by the first output step to the module via the interface of the module into which the first interface is converted.

In the bridge method according to the present invention, the conversion step performs the conversion into the first interface based on information concerning the module.

In the bridge method according to the present invention, the discrimination step discriminates to which hardware model the operation instruction is issued based on information concerning the hardware model.

Further, to solve the above problem, according to a third aspect of the present invention, there is provided a simulator comprising: a plurality of modules having different configurations from each other which are implemented by software or hardware; at least one hardware model obtained by modeling hardware with software; an acquisition section that acquires an operation instruction issued from the module to hardware model; a conversion section that converts the interface of the module into a first interface corresponding to the hardware model; a discrimination section that acquires the operation instruction acquired by the acquisition section via the first interface into which the interface of the module is converted by the conversion section, discriminates to which hardware model the operation instruction is issued, and outputs the operation instruction to the discriminated hardware model.

The simulator according to the present invention further comprises: a first output section that acquires an operation status of the hardware model output in response to the operation instruction from the hardware model and outputs the operation status via the first interface into which the interface of the module is converted by the conversion section; and a second output section that converts the first interface into the interface of the module and outputs the operation status output by the first output section to the module via the interface of the module into which the first interface is converted.

In the simulator according to the present invention, the conversion section performs the conversion into the first interface based on information concerning the module.

In the simulator according to the present invention, the discrimination section discriminates to which hardware model the operation instruction is issued based on information concerning the hardware model.

According to the present invention, an operation instruction can be issued from a plurality of modules having different configurations which are implemented by software or hardware to a hardware model obtained by modeling hardware with software.

### BRIEF DESCRIPTION OF THE DRAWINGS

FIG. 1 is a view showing a configuration of a simulator in an embodiment of the present invention;

FIG. 2 is a flowchart showing operation instruction processing flow from a CPU model section to a peripheral hardware model section in the embodiment of the present invention; and

FIG. 3 is a flowchart showing processing of outputting operation execution information from the peripheral hardware model section 20 to the CPU model section 10.

### DETAILED DESCRIPTION OF THE PREFERRED EMBODIMENTS

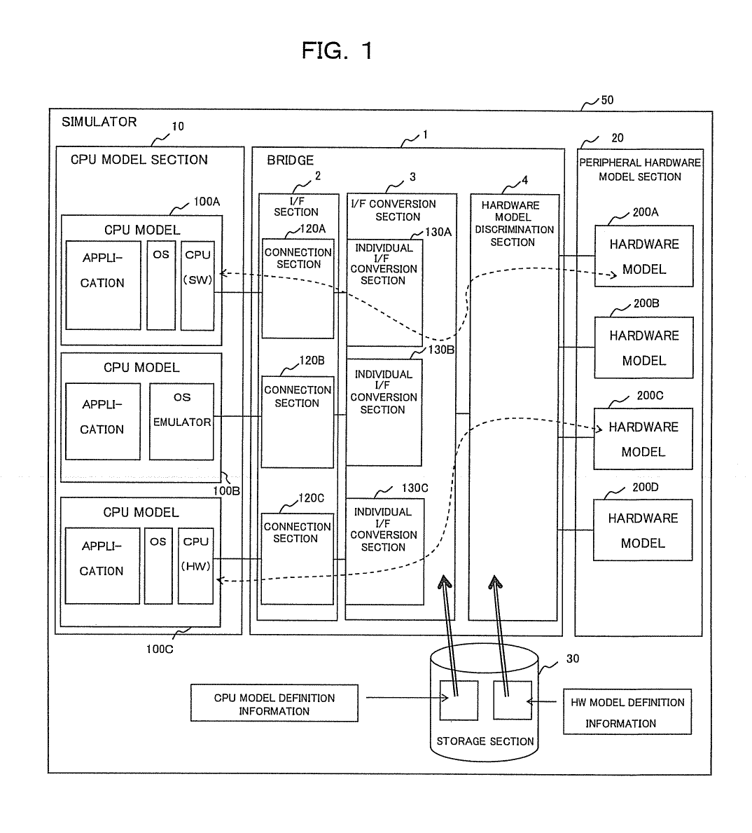

An embodiment of the present invention will be described with reference to the accompanying drawings. A configuration of a simulator according to the present embodiment is shown in FIG. 1.

A simulator 50 includes a CPU model section 10, a peripheral hardware model section 20, a bridge 1 for mediating mutual access between the CPU model section 10 and peripheral hardware model section 20, and a storage section 30.

The CPU model section 10 includes CPU models (modules). Each CPU model has at least a function as a CPU, and further has a function as OS that runs on the CPU and a function as an application that runs on the OS.

In the present embodiment, a CPU model 100A is constituted by a CPU (represented as “CPU (SW)” in FIG. 1) that is configured by software so as to simulate the CPU function and an OS and application running on the CPU. A CPU model 100B has a configuration implemented by an OS emulator (software) including the CPU function. A CPU model 100C is constituted by a minimum hardware configuration (CPU (represented as “CPU (HW)” in FIG. 1)) required for running an OS, a memory (RAM or ROM, etc.), and an OS and application running on the CPU. The CPU model 100C includes a PCI board, which is bus-connected to the minimum hardware configuration.

Although the hardware configuration of the simulator 50 is achieved by PCI connection between the CPU model 100C and personal computer, it is only necessary for the simulator 50 to have the configuration as described in the present embodiment, in which functions as the CPU model and hardware model are included and data can be exchanged between the CPU model and hardware model.

The peripheral hardware model section 20 is obtained by implementing, by software, the function of peripheral hardware other than that included in the CPU model section 10 and includes hardware models (hardware model 200A, hardware model 200B, . . . ) obtained by converting respective peripheral hardware components into a software configuration.

The storage section 30 previously stores CPU model definition information as information concerning the respective CPU models in the CPU model section 10. Further, the storage section 30 previously stores hardware model definition information as information concerning respective hardware models in the peripheral hardware model section 20.

The bridge 1 mediates mutual access between the CPU model section 10 and peripheral hardware model section 20. The bridge 1 in the present embodiment includes an interface section 2 (I/F section), an interface conversion section 3 (I/F conversion section), and a hardware model discrimination section 4.

The interface section 2 enables connection between the specific interface of each CPU model in the CPU model section 10 and bridge 1 and acquires an operation instruction for each hardware model of the peripheral hardware model section 20 from each CPU model.

The interface section 2 includes connection sections. Each of the connection sections is connected to a corresponding CPU model. In the present embodiment, a connection section 120A is connected to the CPU model 100A, connection section 120B is connected to the CPU model 100B, and connection section 120C is connected to the CPU model 100C. The connection section 120C is connected to a CPU model (CPU model 100C) constituted by hardware using a PCI board's device driver.

The interface section 2 previously divides the memory area of a memory of the simulator 50 for each CPU model and assigns the obtained memory area to each connection section. Each connection section makes the assigned memory area function as a register of a corresponding CPU model. In acquiring the operation instruction from each CPU model, each connection section stores the operation instruction in the register.

Further, the interface section 2 mediates information output from each hardware model of the peripheral hardware model section 20 to each CPU model.

The interface conversion section 3 converts the specific interfaces, which are connected at the interface section 2, having different connection configurations from each other into a common interface (first interface) corresponding to the peripheral hardware model section 20 based on the CPU model definition information stored in the storage section 30. The interface conversion section 3 includes individual interface conversion sections (individual I/F conversion sections) corresponding to the respective connection sections of the interface section 2, each of which performs conversion into the common interface.

The CPU model definition information defines correspondence among identification information (CPU model ID) of each CPU model of the CPU model section 10, each connection section of the interface section 2, and each individual interface conversion section. That is, the interface conversion section 3 detects which connection section has acquired the operation instruction to thereby identify corresponding CPU model ID and individual interface conversion section based on the CPU model definition information and causes the identified individual interface conversion section to perform the conversion. The CPU model definition information may define correspondence among the CPU model ID, each memory area corresponding to each connection section, and individual interface conversion section. In this case, the interface conversion section 3 needs to detect to which memory area an access has been made.

The individual interface conversion section achieves conversion into the common interface by means of file transfer or API (Application Program Interface). Further, at least identification information (CPU model ID) of the CPU model which is a transmission source of the operation instruction and identification information (operation instruction ID) of the operation instruction are added to the operation instruction exchanged via the common interface. The operation instruction ID is defined in the interface conversion section 3 and is added based on the operation instruction acquired by each connection section of the interface section 2.

In the present embodiment, the individual interface conversion section 130A corresponds to the connection section 120A, individual interface conversion section 130B corresponds to the connection section 120B, and individual interface conversion section 130C corresponds to the connection section 120C.

The interface conversion section 3 also performs conversion from the common interface into the specific interface of each CPU model so as to mediate information output from the hardware model to the CPU model.

The hardware model discrimination section 4 acquires the operation instruction acquired by the interface section 2 via the common interface into which the specific interface is converted by the interface conversion section 3, discriminates to which hardware model the acquired operation instruction has been issued based on the hardware model definition information stored in the storage section 30, and outputs the operation instruction to the target hardware model.

The hardware model definition information defines correspondence among the operation instruction ID, hardware model, and operation of the hardware model. That is, the hardware model discrimination section 4 checks the operation instruction ID included in the data of the operation instruction acquired via the common interface against the hardware model definition information to thereby identify the hardware model and the operation thereof and then outputs the operation to the identified target hardware model. Further, the hardware model discrimination section 4 holds CPU model ID included in the data of the operation instruction.

The hardware model discrimination section 4 acquires information (operation execution information) such as operation status from the hardware model and outputs the acquired operation execution information to the interface conversion section 3 via the common interface.

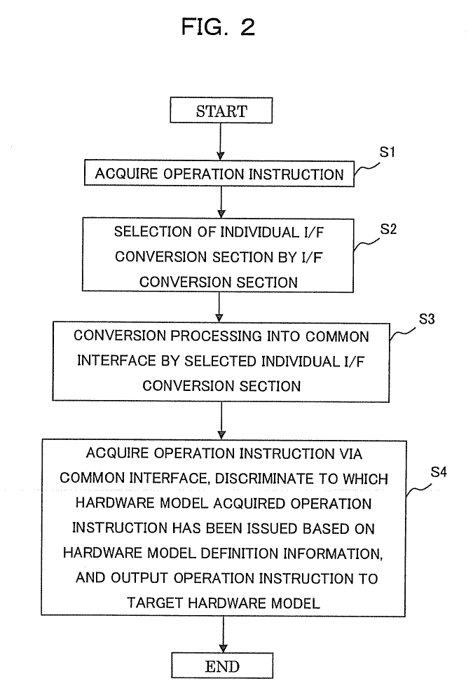

The processing performed in the simulator 50 will be described below. First, the operation instruction processing flow from the CPU model section 10 to the peripheral hardware model section 20 will be described with reference to a flowchart of FIG. 2. Although the operation instruction is issued from the CPU model 100A of the CPU model section 10 to the hardware model 200A of the peripheral hardware model section 20 in this example, correspondence between the CPU model and hardware model may be changed arbitrarily.

The interface section 2 acquires the operation instruction from the CPU model 100A by the connection section 120A (step S1).

The interface conversion section 3 selects the individual interface conversion section that performs conversion processing based on the CPU model definition information (step S2). In this case, the individual interface conversion section 130A is selected.

The individual interface conversion section 130A converts the specific interface of the CPU model 100A into the common interface (step S3).

The hardware model discrimination section 4 acquires the operation instruction from the individual interface conversion section 130A (interface conversion section 3) via the common interface. Further, the hardware model discrimination section 4 discriminates to which hardware model of the peripheral hardware model section 20 the acquired operation instruction has been issued based on the hardware model definition information, and outputs the operation instruction to the target hardware model (step S4). In this case, the hardware model discrimination section 4 discriminates that the operation instruction has been issued to the hardware model 200A and outputs the operation instruction to the hardware model 200A.

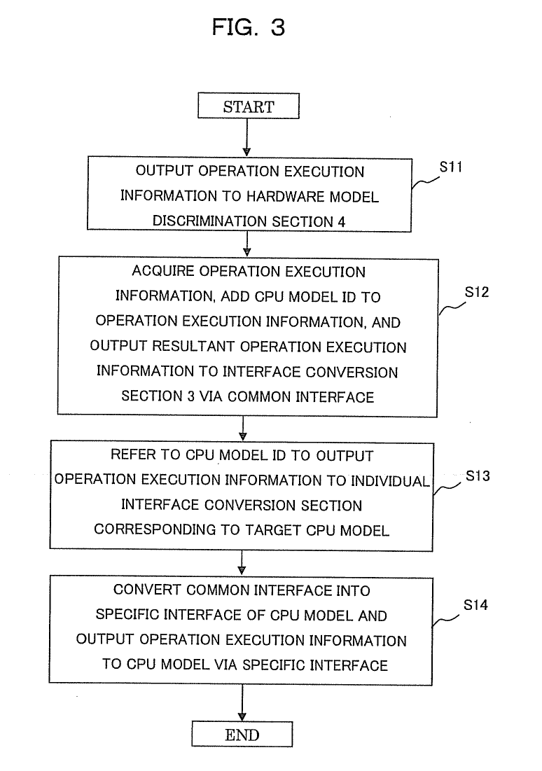

Next, the processing of outputting the operation execution information (information such as operation status of the hardware model output in response to the operation instruction) from the peripheral hardware model section 20 to the CPU model section 10 will be described with reference to FIG. 3. Although the operation execution information is issued from the hardware model 200A of the peripheral hardware model section 20 to the CPU model 100A of the CPU model section 10 in this example, correspondence between the CPU model and hardware model may be changed arbitrarily as in the case of the abovementioned operation instruction processing.

The hardware model 200A outputs the operation execution information for the received operation instruction to the hardware model discrimination section 4 (step S11).

The hardware model discrimination section 4 acquires the operation execution information, adds the CPU model ID (identification information indicating to which CPU model the operation execution information is transmitted) to the operation execution information, and outputs the resultant operation execution information to the interface conversion section 3 via the common interface (step S12).

The interface conversion section 3 refers to the CPU model ID to output the operation execution information to the individual interface conversion section corresponding to the target CPU model (step S13). In this case, the operation execution information is output to the individual interface conversion section 130A.

Upon reception of the operation execution information, the individual interface conversion section 130A converts the common interface into the specific interface of each CPU model. Further, the individual interface conversion section 130A outputs the operation execution information to the CPU model of the CPU model section via the corresponding connection section of the interface section 2 (step S14). In this case, the operation execution information is output to the CPU model 100A via the connection section 120A.

In outputting the operation execution information from the connection section 120A to the CPU model 100A, a value containing the operation execution information is stored in a predetermined register in the memory area assigned to the connection section 120A. After that, when an access is made to the predetermined register, an interruption to the CPU model 100A occurs, whereby the CPU model 100A acquires the operation execution information from the predetermined register.

As described above, the bridge 1 absorbs the difference in the connection configurations of the interfaces between the CPU model and hardware model and provides a common interface to the hardware model, thereby enabling common use of the hardware model.

Further, addition of a bridge function is easier to be achieved than development of a new hardware model, so that it is possible to constitute a simulate environment at short times.

Further, the reuse of the existing hardware model is made possible, so that quality of the hardware model can be increased while development cost and development time thereof can be reduced.

An acquisition section corresponds to the interface section 2 in the embodiment, and a conversion section corresponds to the interface conversion section 3 in the embodiment. A discrimination section and a first output section correspond to the hardware model discrimination section 4 in the embodiment, and a second output section corresponds to the interface section 2 and interface conversion section 3.

Although the module is described as CPU model in the present embodiment, any module may be used as long as it can output the operation instruction to the hardware model.

Although the bridge program is previously installed in the simulator in the present embodiment, the bridge program of the present invention may be stored in a storage medium. The storage medium mentioned here includes all media that can be read and executed by a computer in the simulator. Examples of such media include a medium detachable from the simulator such as a magnetic tape, magnetic disk (floppy disk, hard disk drive, etc.), optical disk (CD-ROM, DVD disk, etc.), a magneto-optical disk (MO, etc.), flash memory, or the like and a medium that can be transmitted through a network.

What is claimed is:

1. A bridge program allowing a computer to connect a plurality of modules having different configurations from each other which are implemented by software or hardware and at least one hardware model obtained by modeling hardware with software, the program allowing the computer to execute:
an acquisition step that acquires an operation instruction issued from the module to hardware model;
a conversion step that converts the interface of the module into a first interface corresponding to the hardware model; and
a discrimination step that acquires the operation instruction acquired by the acquisition step via the first interface into which the interface of the module is converted by the conversion step, discriminates to which hardware model the operation instruction is issued, and outputs the operation instruction to the discriminated hardware model.

2. The bridge program according to claim 1 allowing the computer to execute:
a first output step that acquires an operation status of the hardware model output in response to the operation instruction from the hardware model and outputs the operation status via the first interface into which the interface of the module is converted by the conversion step; and
a second output step that converts the first interface into the interface of the module and outputs the operation status output by the first output step to the module via the interface of the module into which the first interface is converted.

3. The bridge program according to claim 1, wherein
the conversion step performs the conversion into the first interface based on information concerning the module.

4. The bridge program according to claim 1, wherein
the discrimination step discriminates to which hardware model the operation instruction is issued based on information concerning the hardware model.

5. A bridge method that connects a plurality of modules having different configurations from each other which are implemented by software or hardware and at least one hardware model obtained by modeling hardware with software, comprising:
an acquisition step that acquires an operation instruction issued from the module to hardware model;
a conversion step that converts the interface of the module into a first interface corresponding to the hardware model; and
a discrimination step that acquires the operation instruction acquired by the acquisition step via the first interface into which the interface of the module is converted by the conversion step, discriminates to which hardware model the operation instruction is issued, and outputs the operation instruction to the discriminated hardware model.

6. The bridge method according to claim 5 comprising:
a first output step that acquires an operation status of the hardware model output in response to the operation instruction from the hardware model and outputs the operation status via the first interface into which the interface of the module is converted by the conversion step; and
a second output step that converts the first interface into the interface of the module and outputs the operation status output by the first output step to the module via the interface of the module into which the first interface is converted.

7. The bridge method according to claim 5, wherein
the conversion step performs the conversion into the first interface based on information concerning the module.

8. The bridge method according to claim 5, wherein
the discrimination step discriminates to which hardware model the operation instruction is issued based on information concerning the hardware model.

9. A simulator comprising:
a plurality of modules having different configurations from each other which are implemented by software or hardware;
at least one hardware model obtained by modeling hardware with software;
an acquisition section that acquires an operation instruction issued from the module to hardware model;
a conversion section that converts the interface of the module into a first interface corresponding to the hardware model; and
a discrimination section that acquires the operation instruction acquired by the acquisition section via the first interface into which the interface of the module is converted by the conversion section, discriminates to which hardware model the operation instruction is issued, and outputs the operation instruction to the discriminated hardware model.

10. The simulator according to claim 9, comprising:
a first output section that acquires an operation status of the hardware model output in response to the operation instruction from the hardware model and outputs the operation status via the first interface into which the interface of the module is converted by the conversion section; and
a second output section that converts the first interface into the interface of the module and outputs the operation status output by the first output section to the module via the interface of the module into which the first interface is converted.

11. The simulator according to claim 9, wherein
the conversion section performs the conversion into the first interface based on information concerning the module.

12. The simulator according to claim 9, wherein
the discrimination section discriminates to which hardware model the operation instruction is issued based on information concerning the hardware model.
